(19) United States
(12) Patent Application Publication
(10) Pub. No.: US 2005/0010508 A1
(43) Pub. Date: Jan. 13, 2005

(54) Non-scalar-valued financial instruments

(76) Inventor: Marc Michael Groz, Stamford, CT (US)

Correspondence Address: MARC M GROZ;Apt S-1602, 1450 Washington Blvd., Stamford, CT, 06902, US

(21) Appl. No.: 10/733,483

(22) Filed: Dec. 11, 2003

Related U.S. Application Data
(60) Provisional application No. 60/432,852, filed on Dec. 12, 2002.

(51) Int. Cl. G06F 17/60

(52) U.S. Cl. 705/35

(57) ABSTRACT

A method and system is disclosed for creating and using non-scalar valued financial instruments. The method and system addresses the problems caused by limiting the value of financial instruments to scalar quantities. Applications of the method and system include recreation, education, therapeutic intervention, and finance.

### CROSS REFERENCE TO RELATED APPLICATION

This application claims benefit of U.S. Provisional Patent Application No. 60/432,852, filed Dec. 12, 2002, which is hereby incorporated by reference.

### BACKGROUND OF THE INVENTION

By scalar-valued financial instrument (“SFI”) I mean a financial instrument whose value is completely represented as a magnitude of a currency. Note that the value of an SFI may be unknown, subject to measurement error, or valued differently at different times and places and by different people (“value assessors”). Nonetheless, despite disagreements, uncertainties, and variability in value, a scalar-valued financial instrument has, by definition, a unique value in a given context. The context of a valuation may include time, place, value assessor, actual owner, hypothetical owner, other interested parties, or other relevant factors such as interest rates, exchange rates, and other financial or economic variables.

SFIs may be Real or Imaginary:
A real SFI is an SFI whose value is completely represented in a real currency, e.g., U.S. dollars. Examples of real SFIs include, United States Savings Bonds, shares of common stock in a corporation, and IOUs. Currencies such as euros, dollars, and yen are themselves special kinds of real SFIs.
An imaginary SFI is an SFI whose value is represented in an imaginary currency. An imaginary currency is a currency with no actual value that may be used to play a game. An example is the currency used to play the game of Monopoly®. Financial instruments denominated in “Monopoly money” or some other “play money” would be examples of imaginary SFIs.

All Existing Financial Instruments are Scalar-Valued:
Commerce and games that are played for money use real currencies or other real SFIs.
Other games sometimes use imaginary SFIs, typically “play money.”

Considered as commodities, games are purchased and sold using real currencies. In particular, “play money” may be bought or sold with real money. More generally, real SFIs may be traded for imaginary SFIs.

There are several contexts in which it would be useful to have a different type of financial instrument that extends the concept of financial instrument beyond the realm of scalar values. As explained in the next section, these contexts include:
Education
Rehabilitation
Recreation
Commerce

Scalar values are enormously useful, enabling global commerce and providing a method of score-keeping in games that use either real money or play money. Nonetheless, value is not always adequately represented in scalar terms; values don't always line up on a single scale.

Human abilities to imagine, to simulate, or to create virtual worlds are examples of contexts in which non-scalar values may operate. All humans have the ability to imagine, engaging in “what if” exercises of varying degrees of sophistication and likelihood. The scalar model of value forces us to segregate our imagination from the world. This results in a misrepresentation of the relationship between the virtual and the real, with enormous consequences for our health and well-being, and for the health and well-being of those around us.

By reconnecting the domain of imaginary values with the domain of real values, and extending such domains to even more elaborate structures, we will be able to capture much more of the complexity of the world than we do at present. Such structures can help us learn better, overcome bad habits, and can act as a spur to creativity and economic growth.

### BRIEF SUMMARY OF THE INVENTION

We may define a non-scalar-valued financial instrument (“NFI”) as a financial instrument whose value is not completely represented by a magnitude in a currency. A class of NFIs is categorized by reference to a corresponding non-scalar value structure.

Following are Examples of Some Instrument Classes and Associated Value Structures:
Surreal-valued financial instruments, whose value is a surreal number (as defined in On Numbers and Games, John H. Conway, 2001, 2^{nd} edition).
   (Value Structure: Class No of Surreal Numbers)
Complex-valued financial instruments, whose value is of the form A+Bi, where A,B are real numbers and i is the square root of −1.
   (Value Structure: Field of Complex Numbers)
Vector-valued financial instruments, whose value is of the form AX, where A={a₁, . . . ,aₙ } is a real vector and X={x₁, . . . ,xₙ} is a set of unit vectors.
   (Value Structure: Vector Space of Dimension n)
Tensor-valued financial instruments, whose value is of the form A_{x1 . . .} where A is a tensor of rank n with indices x₁, . . . ,xₙ.
   (Value Structure: Vector Space of Dimension n)

### BRIEF DESCRIPTION OF THE DRAWINGS

The above summary of the invention will be better understood when taken in conjunction with the following detailed description and accompanying drawings in which:

FIG. 1 is a flow chart of a preferred embodiment of the operation and use of the invention for recreation.

FIG. 2 is a flow chart of a preferred embodiment of the operation and use of the invention for education.

FIG. 3 is a flow chart of a preferred embodiment of the operation and use of the invention for therapeutic intervention.

FIG. 4 is a flow chart of a preferred embodiment of the operation and use of the invention for trading financial instruments.

### DETAILED DESCRIPTION OF THE INVENTION

As referred to herein, games may include (without limitation) board games, online individual games, online multi-player games, individual and team sports, and games that are played for prizes in the form of money or other financial consideration.

As referred to herein, financial instruments may include (without limitation): equity securities; debt securities; hybrid securities; derivative securities; private placements; other instruments (registered or unregistered) subject to securities law; commodities contracts; futures contracts; insurance contracts; other private contracts; currencies of sovereign nations; and currencies of other entities such as the European Union.

In a preferred embodiment, an NFI may be represented or identified with one or more physical certificates, which may, for example and without limitation, be made of paper, plastic, or other appropriate material. Said NFI may have information printed or otherwise attached to the physical certificate.

In a preferred embodiment, a complex-valued NFI may have its value, in Cartesian and/or polar coordinates, printed on one or both sides of a paper certificate; a vector-Valued NFI may be represented or identified with a set of papers, one for each unit vector of the canonical basis of the associated vector space.

In an alternative preferred embodiment, an NFI may be represented or identified with one or more components of a computer system. Said computer system may (for example and without limitation) be electronic, optical, DNA-based, or a quantum computer capable of operations using quantum bits (qubits) and entangled quantum states.

In a preferred embodiment, a surreal-valued NFI may be represented by a program whose output corresponds to the surreal number associated with said NFI; a tensor-valued NFI may be represented by a data file corresponding to the tensor associated with said NFI.

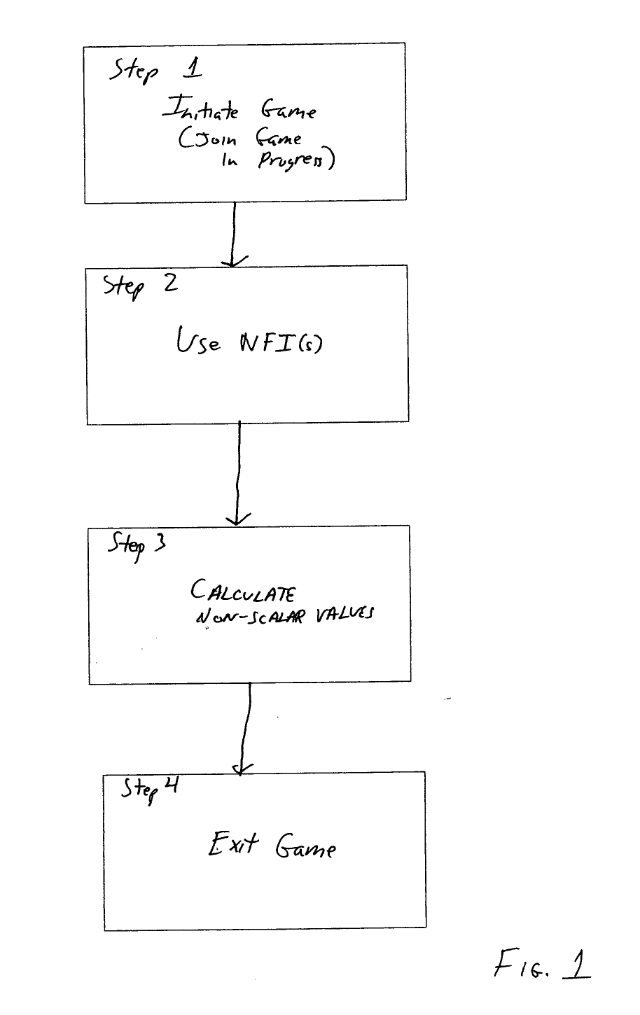

A preferred embodiment for operation and use of the invention for recreation is now described in connection with FIG. 1.

As shown in FIG. 1, step 1, one or more players initiate a game(or join a game already in progress). In step 2, one or more players uses one or more NFIs in the course of play. In step 3, the value of one or more NFIs is calculated one or more times in relationship to the playing of the game. In step 4, one or more players exits the game.

In a preferred embodiment, surreal, complex, vector or tensor-valued currencies or other financial instruments may be used for recreation.
Surreal numbers may be defined in terms of strength of position in one or more games (cf. Conway, 2001). Surreal-valued NFIs may have the value of the strength of position in one or more games associated with the NFI. Using said NFI, players may engage in simultaneous play of a plurality of games by playing one “meta-game” which may use said NFI to keep score.
Complex numbers consist of real and imaginary parts. Complex-valued NFIs may be used to play games in which the real and imaginary components operate independently. They may also be used to play games in which the real and imaginary components interact. Using said NFIs, players may engage in games in which both real and imaginary values change hands, and in which the relationship between the magnitude of said real and imaginary values may change during the course of play.
Vector or tensor-valued NFIs may be used to play games in which their respective units operate independently or interact. Using said NFIs, players may engage in games in which a plurality of distinct values change hands, and in which the relationship between the magnitude of said plurality of distinct values may change during the course of play.

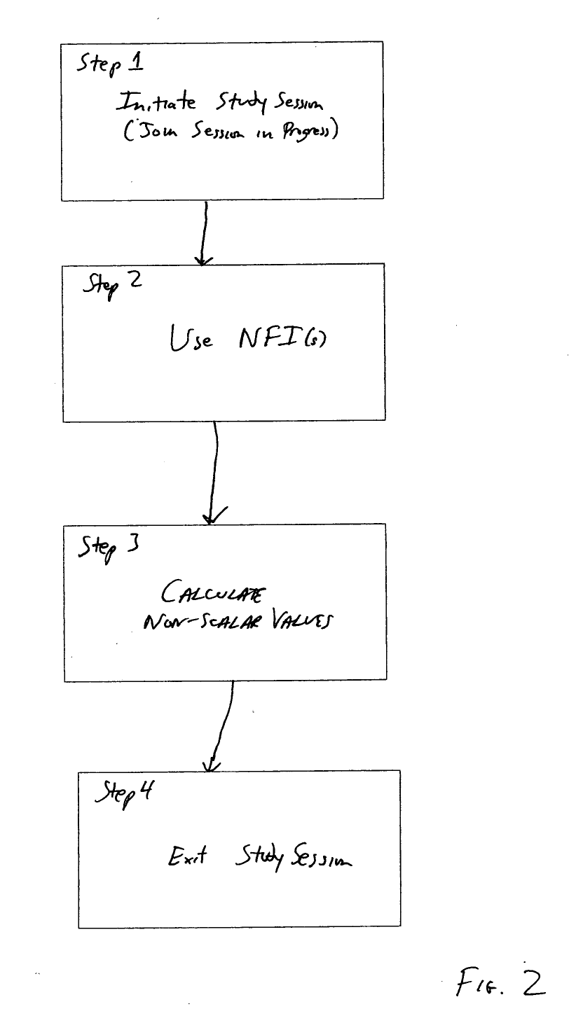

A preferred embodiment for operation and use of the invention for education is now described in connection with FIG. 2.

As shown in FIG. 2, step 1, one or more students and/or teachers (“learners”) initiate a study session (or join a session already in progress). In step 2, one or more learners uses one or more NFIs in the course of study. In step 3, the value of one or more NFIs is calculated one or more times in relationship to the study session. In step 4, one or more learners exits the study session.

In a preferred embodiment, surreal, complex, vector or tensor-valued currencies or other financial instruments, to be used for education. Educational processes may be modeled in game-theoretic terms. For example, report cards and/or standardized test results may be linked to a set of currencies to create vector-valued financial instruments. One or more of the currencies may be associated with or convertible into real and/or imaginary currencies. Real currencies may preferably be used to fund scholarships and other educational stipends. Real and/or imaginary currencies may preferably be used to award prizes in educational games.
Surreal numbers may be defined in terms of strength of position in one or more games (cf. Conway, 2001). Surreal-valued NFIs may have the value of the strength of position in one or more games associated with the NFI. Using said NFI, players may engage in simultaneous play of a plurality of games by playing one “meta-game” which may use said NFI to keep score.
Complex numbers consist of real and imaginary parts. Complex-valued NFIs may be used to play games in which the real and imaginary components operate independently. They may also be used to play games in which the real and imaginary components interact. Using said NFIs, players may engage in games in which both real and imaginary values change hands, and in which the relationship between the magnitude of said real and imaginary values may change during the course of play.
Vector or tensor-valued NFIs may be used to play games in which their respective units operate independently or interact. Using said NFIs, players may engage in games in which a plurality of distinct values change hands, and in which the relationship between the magnitude of said plurality of distinct values may change during the course of play.

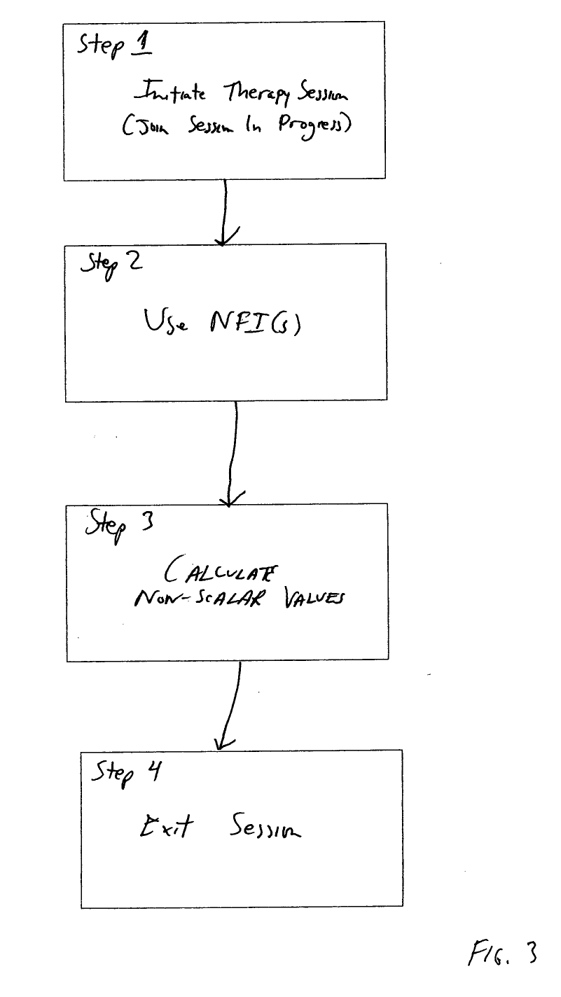

A preferred embodiment for operation and use of the invention for therapeutic intervention is now described in connection with FIG. 3.

As shown in FIG. 3, step 1, one or more patients and/or therapists initiate a therapeutic session (or join a session already in progress). In step 2, one or more patients and/or therapists uses one or more NFIs in the course of therapy. In step 3, the value of one or more NFIs is calculated one or more times in relationship to the therapy session. In step 4, one or more learners exits the therapy session.

In a preferred embodiment, surreal, complex, vector or tensor-valued currencies or other financial instruments, to be used for therapeutic intervention. Therapeutic interventions may be modeled in game-theoretic terms. For example, therapeutic evaluations and/or medical or psychological test results may be linked to a set of currencies to create vector-valued financial instruments. One or more of the currencies may be associated with or convertible into real and/or imaginary currencies. Real currencies may preferably be used to fund treatments and other therapeutic interventions. Real and/or imaginary currencies may preferably be used to award prizes in therapeutic games.
Surreal numbers may be defined in terms of strength of position in one or more games (cf. Conway, 2001). Surreal-valued NFIs may have the value of the strength of position in one or more games associated with the NFI. Using said NFI, players may engage in simultaneous play of a plurality of games by playing one “meta-game” which may use said NFI to keep score.
Complex numbers consist of real and imaginary parts. Complex-valued NFIs may be used to play games in which the real and imaginary components operate independently. They may also be used to play games in which the real and imaginary components interact. Using said NFIs, players may engage in games in which both real and imaginary values change hands, and in which the relationship between the magnitude of said real and imaginary values may change during the course of play.
Vector or tensor-valued NFIs may be used to play games in which their respective units operate independently or interact. Using said NFIs, players may engage in games in which a plurality of distinct values change hands, and in which the relationship between the magnitude of said plurality of distinct values may change during the course of play.

In a preferred embodiment, said NFIs may be used as part of a system for mitigating the financial and other consequences of addictive or compulsive gambling. For example, complex-valued NFIs may be issued to addictive or compulsive gamblers in the form of game cards, chips, or other tokens that may represent their value. The nature of the wager—in particular, the proportion of real value to imaginary value being wagered—may be automatically adjusted by the system managing play. The use of complex currency may help protect the gambler from the consequences of his or her compulsive or addictive behavior.

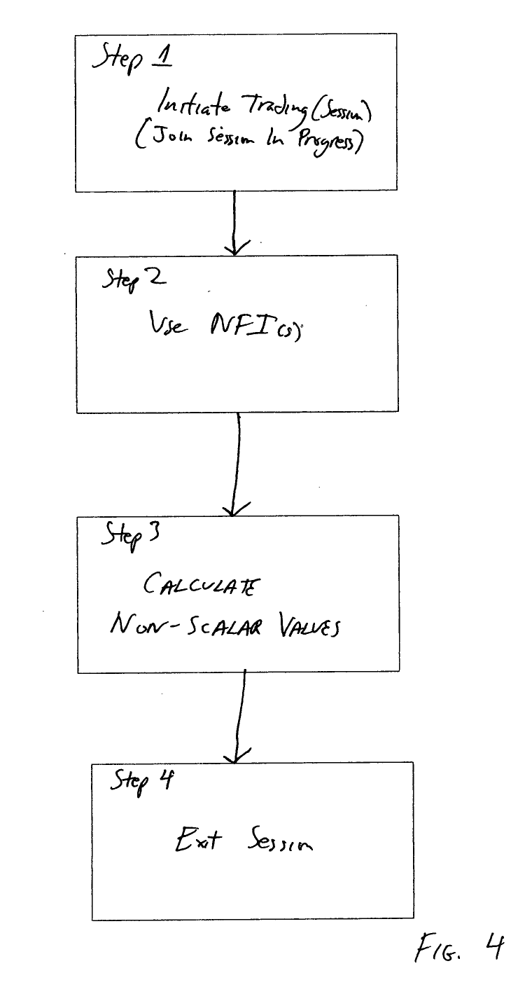

A preferred embodiment for operation and use of the invention for trading financial instruments is now described in connection with FIG. 4.

As shown in FIG. 4, step 1, one or more traders initiate a trading session (or join a session already in progress). In step 2, one or more traders uses one or more NFIs in the course of trading. In step 3, the value of one or more NFIs is calculated one or more times in relationship to the trading session. In step 4, one or more traders exits the study session.

In a preferred embodiment, surreal, complex, vector, or tensor-valued currencies or other financial instruments, for trading financial instruments. Financial instrument trading may be modeled in game-theoretic terms. Used in the context of a trading operation, NFIs may facilitate training of traders and other operations staff, risk management and mitigation, and testing and/or optimization of trading strategies.
Surreal numbers may be defined in terms of strength of position in one or more games (cf. Conway, 2001). Surreal-valued NFIs may have the value of the strength of position in one or more games associated with the NFI. Using said NFI, players may engage in simultaneous play of a plurality of games by playing one “meta-game” which may use said NFI to keep score.
Complex numbers consist of real and imaginary parts. Complex-valued NFIs may be used to play games in which the real and imaginary components operate independently. They may also be used to play games in which the real and imaginary components interact. Using said NFIs, players may engage in games in which both real and imaginary values change hands, and in which the relationship between the magnitude of said real and imaginary values may change during the course of play.
Vector or tensor-valued NFIs may be used to play games in which their respective units operate independently or interact. Using said NFIs, players may engage in games in which a plurality of distinct values change hands, and in which the relationship between the magnitude of said plurality of distinct values may change during the course of play.

In a preferred embodiment, training of traders may be facilitated by use of complex-valued NFIs. Managers or other parties may provide each trader with an absolute value V to be traded, along with a training parameter P. Different traders may be assigned different values for V and P. Each (V,P) corresponds to a complex-valued currency, expressed in polar coordinates (r, θ). Initially, P may be set to Π/2 (90 degrees), meaning that the trader is trading a purely imaginary currency. Subsequently, P may be adjusted in accordance with said trader's trading results and preferably other factors, which may include market conditions and the firm's trading position. Said trader's knowledge of the value of training parameter P may preferably be controlled by said managers or other parties. For training purposes, traders may agree to trade in complete ignorance of P's value. Said traders, may, for example, sometimes be given a random value for P.

In an alternative preferred embodiment, risk management may be facilitated by use of complex-valued NFIs. Risk managers or other parties may provide each trader with an absolute value V to be traded, along with a risk management parameter P. Different traders may be assigned different values for V and P. Each (V,P) correspond to a value of a complex-valued currency, expressed in polar coordinates (r, θ). Initially, P may be set to Π/2 (90 degrees), meaning that the trader is trading a purely imaginary currency. Subsequently, P may be adjusted in accordance with risk management criteria and preferably other factors, which may include the trader's results, market conditions and the firm's trading position. Said trader's knowledge of the value of risk management parameter P may preferably be controlled by said managers or other parties. For risk management purposes, traders may agree to trade in complete ignorance of P's value. Said traders, may, for example, sometimes be given a random value for P.

In another alternative preferred embodiment, testing and optimization of trading strategies may be facilitated by use of complex-valued NFIs. Quantitative strategists or other parties may provide each trader with an absolute value V to be traded, along with a training parameter P. Different traders may be assigned different values for V and P. Each (V,P) correspond to a value of a complex-valued currency, expressed in polar coordinates (r, θ). Initially, P may be set to Π/2 (90 degrees), meaning that the trader is trading a purely imaginary currency. Subsequently, P may be adjusted in accordance with testing and/or optimization criteria and preferably other factors, which may include the trader's results, market conditions and the firm's trading position. Said trader's knowledge of the value of parameter P may preferably be controlled by said managers or other parties. For testing and optimization purposes, traders may agree to trade in complete ignorance of P's value. Said traders, may, for example, sometimes be given a random value for P.

1. A method for creating and using non-scalar-valued financial instruments, said method comprising:
selecting a non-scalar value structure;
defining a financial instrument, the financial instrument having a plurality of characteristics, the step of defining comprising:
selecting a type for the financial instrument;
selecting a set of terms and conditions for the financial instrument, the terms and conditions containing one or more references to non-scalar values of said non-scalar value structure.

2. The method of claim 1, where the non-scalar value structure is the class of surreal numbers.

3. The method of claim 1, where the non-scalar value structure is the field of complex numbers.

4. The method of claim 1, where the non-scalar value structure is a vector space of dimension n.

5. The method of claim 1, where the type of said financial instrument is an equity security.

6. The method of claim 1, where the type of said financial instrument is a debt security

7. The method of claim 1, where the type of said financial instrument is a hybrid security.

8. The method of claim 1, where the type of said financial instrument is a derivative security.

9. The method of claim 1, where the type of said financial instrument is a private placement.

10. The method of claim 1, where the type of said financial instrument is an instrument subject to securities law.

11. The method of claim 1, where the type of said financial instrument is a commodities contract.

12. The method of claim 1, where the type of said financial instrument is a futures contract.

13. The method of claim 1, where the type of said financial instrument is an insurance contract.

14. The method of claim 1, where the type of said financial instrument is a private contract.

15. The method of claim 1, where the type of said financial instrument is a currency.

16. The method of claim 15, where said currency is a currency of a sovereign nation.

17. The method of claim 1, where the conditions include provisions for one or more non-scalar-valued transactions among a plurality of parties.

18. The method of claim 1, where the NFI is represented in an online system.

19. The method of claim 18, where said system is a trading system.

20. The method of claim 18, where said system is an online gaming system.

21. The method of claim 20, where said online gaming system is a multiplayer gaming system.

22. The method of claim 1, where the financial instrument is used in an educational setting.

23. The method of claim 1, where the financial instrument is used in a recreational context.

24. The method of claim 1, where the financial instrument is used in a therapeutic context.

25. The method of claim 24, where said therapeutic context makes use of real and imaginary currencies associated with said non-scalar values.

26. The method of claim 25, where said therapeutic context is associated with a system that monitors the behavior of one or more players.

27. The method of claim 26, where said system dynamically adjusts the players access to said real and imaginary currencies in response to said behavior.

28. The method of claim 1, where the financial instrument is used as part of a financial trading system.

29. The method of claim 28, where said financial trading system is used for training of traders or other operational staff.

30. The method of claim 29, where said training takes place in a real time trading environment.

31. The method of claim 28, where said financial trading system is used for simulation of trading strategies.

32. The method of claim 31, where said simulation takes place in a real-time trading environment.

33. The method of claim 28, where said financial trading system is used for optimization of trading strategies.

34. The method of claim 33, where said optimization takes place in a real-time trading environment.

35. The method of claim 28, where said financial trading system is used for risk management.

36. The method of claim 35, where said risk management takes place in a real-time trading environment.

37. The method of claim 1, where one or more parts of the non-scalar value structure has an equivalent real scalar value.

38. The method of claim 1, where one or more parts of the non-scalar value structure has an equivalent imaginary scalar value.

39. The method of claim 1, where one or more parts of the non-scalar value structure are convertible into an equivalent real scalar value.

40. The method of claim 1, where one or more parts of the non-scalar value structure are convertible into an equivalent imaginary scalar value.

41. A system for creating non-scalar-valued financial instruments, said system comprising:
a means for selecting a non-scalar value structure;
a means for defining a financial instrument, the financial instrument having a plurality of characteristics, said definition comprising:
means for selecting a type for the financial instrument;
means for selecting a set of terms and conditions for the financial instrument, said terms and conditions including one or more references to the non-scalar value structure.

42. The-method of claim 1, wherein said method is facilitated by one or more computers.

43. The method of claim 1, wherein said financial instrument is represented by one or more physical certificates.

44. The method of claim 43, wherein said certificates are made of paper.

45. The method of claim 43, wherein said certificates are made of plastic.

46. The method of claim 1, wherein said financial instrument is identified with one or more physical certificates.

47. The method of claim 45, wherein said certificates are made of paper.

48. The method of claim 45, wherein said certificates are made of plastic.

49. The method of claim 1, wherein said financial instrument is represented by one or more components of a computer system.

50. The method of claim 49, wherein said components are part of an electronic computer system.

51. The method of claim 49, wherein said components are part of a biological computer system.

52. The method of claim 49, wherein said components may be implanted in living tissue.

53. The method of claim 49, wherein said components are part of a quantum computer system.

54. The method of claim 53, wherein said components are protected by quantum cryptography.

55. The method of claim 1, wherein said financial instrument is identified with one or more components of a computer system.

56. The method of claim 55, wherein said components are part of an electronic computer system.

57. The method of claim 55, wherein said components are part of a biological computer system.

58. The method of claim 55, wherein said components may be implanted in living tissue.

59. The method of claim 55, wherein said components are part of a quantum computer system.

60. The method of claim 59, wherein said components are protected by quantum cryptography.
